(19) United States
(12) Patent Application Publication
(10) Pub. No.: US 2016/0152193 A1
(43) Pub. Date: Jun. 2, 2016

(54) COMPONENT HOLDER AND ASSEMBLY HAVING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JIN-LONG FU, Shenzhen (CN); LI-JUN YANG, Shenzhen (CN); CHUN-HUI LI, Shenzhen (CN); SI-JING YANG, Shenzhen (CN); GANG-HUA LIU, Shenzhen (CN)

(21) Appl. No.: 14/585,447

(22) Filed: Dec. 30, 2014

(30) Foreign Application Priority Data
Nov. 28, 2014 (CN) 201410701743.1

(51) Int. Cl. B60R 11/04; F16B 2/24

(52) U.S. Cl. CPC B60R 11/04; F16B 2/245; B60R 2011/004

(57) ABSTRACT

A component holder for a component includes a bracket and two fixing members. The bracket includes a bottom plate and a frame including a number of first side plates and two second side plates perpendicularly to each other. The first side plates and the second side plates are attached to the bottom plate to form a receiving space for receiving the component. The two fixing members are coupled to the two second side plates. Each fixing member includes an elastic board extending into the receiving space and spaced from the corresponding second side plate, to press against the component in a direction perpendicular to the corresponding second side plate.

### FIELD

The subject matter herein generally relates to a component holder and an assembly having the component holder.

### BACKGROUND

Components, such as rear cameras configured to be held in a housing, need to be precisely positioned in the housing first.

### BRIEF DESCRIPTION OF THE DRAWINGS

Implementations of the present technology will now be described, by way of example only, with reference to the attached figures.

FIG. 1 is an exploded, isometric view of an embodiment of a component holder and an component.

FIG. 2 is an assembled, isometric view of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure describes a component holder.

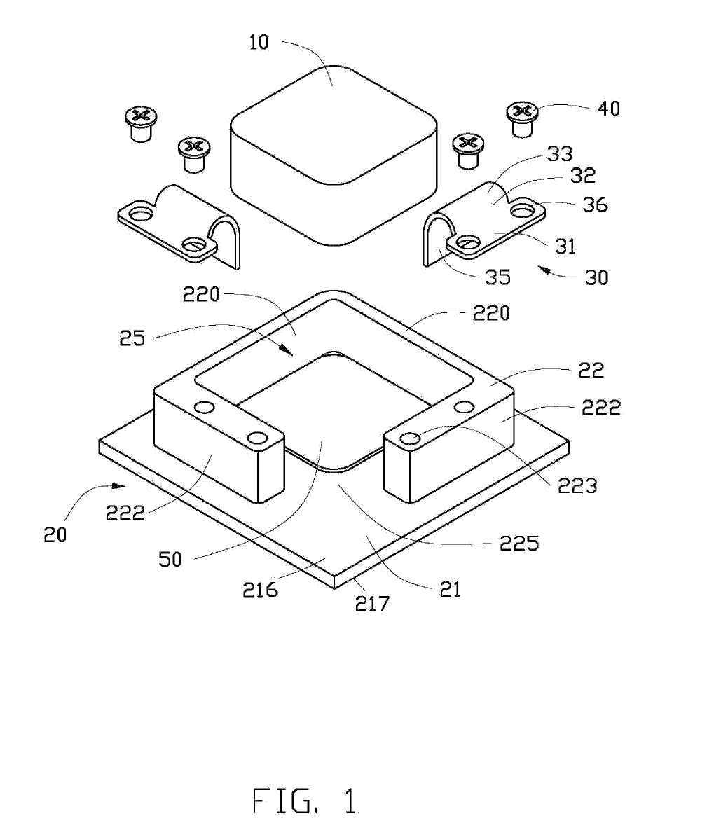

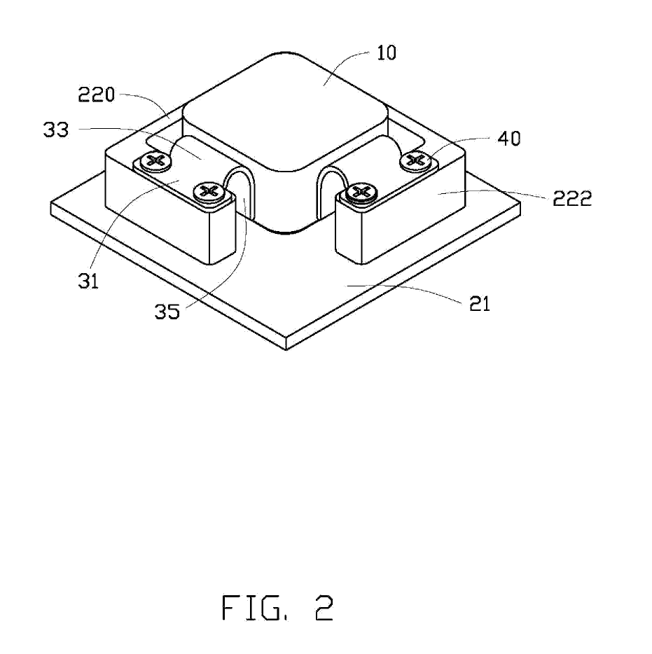

FIGS. 1 and 2 illustrate an embodiment of a component holder for a component 10. In at least one embodiment, the component 10 is a rear camera.

The component holder comprises a bracket 20, two fixing members 30 and a plurality of fastening members 40. In at least one embodiment, the fastening members 40 are screws.

FIG. 1 illustrates that the bracket 20 comprises a bottom plate 21 and a frame 22 attached to the bottom plate 21. The bottom plate 21 has a first surface 216 and a second surface 217 opposite and substantially parallel to the first surface 216. The frame 22 comprises a plurality of first side plates 220, and two second side plates 222 perpendicular to each other. The first side plates 220 and the two second side plates 222 are attached to the bottom plate 21 and extend out substantially perpendicular from the first surface 216 of the bottom plate 21. The first side plates 220, and the two second side plates 222 and the bottom plate 21 bound a receiving space 25. A pair of fixing holes 223 is defined in a top surface of each second side plate 222. In at least one embodiment, a bottom of the component 10 is square, and the quantity of the first side plates 220 is two. The two first side plates 220 are perpendicularly coupled to each other. The two second side plates 222 are coupled to distal ends of the two first side plates 220, respectively. Accordingly, the receiving space 25 bounded by the two first side plates 220, the two second side plates 222 and the bottom plate 21 is square. A notch 225 is defined between neighboring ends of the two second side plates 222. In another embodiment, the receiving space 25 is polygonal, and the bottom of the component 10 is round or polygonal.

FIG. 1 further illustrates that each fixing member 30 comprises a fixing board 31 and an elastic board 32 extending from a side of the fixing board 31. The elastic board 32 comprises a bent portion 33 extending from the side of the fixing board 31 upwards and outwards first and then downwards and outwards, and a contact portion 35 extending downwards from a bottom end of the bent portion 33. A through hole 36 is defined in each of two opposite ends of the fixing board 31. In at least one embodiment, a section of the bent portion 33 is semicircle. The contact portion 35 is perpendicular to the fixing board 31.

FIG. 2 illustrates that in assembly, the two fixing boards 31 of the fixing members 30 are placed on the two second side plates 222, to allow the through holes 36 of each fixing board 31 to align with the fixing holes 223 of the corresponding second side plate 222, and to allow each contact portion 35 to extend into the receiving space 25. The fastening members 40 extend through the through holes 36 of the two fixing boards 31 and engage in the fixing holes 223 of the two second side plates 222, respectively, to fix the fixing members 30 to the second side plates 222. Each contact portion 35 is spaced from an inner surface of the corresponding second side plate 222.

An adhesive tape 50 is ahered to a bottom face of the component 10 or a top surface of the bottom plate 21 in the receiving space 25. The component 10 is inserted into the receiving space 25. Sidewalls of the component 10 face the two second side plates 222, slidably pushing the two bent portions 33 and the two contact portions 35. The two bent portions 33 are deformed to allow each contact portion 35 to press against the component 10 in a direction perpendicular to the corresponding second side plate 222. The component 10 is sandwiched among the two contact portions 35 and the first side plates 220, to prevent the component 10 from being rotated. The component 10 is further pressed downwards to attach the component 10 to the bottom plate 21 by the adhesive tape 50. In at least one embodiment, the adhesive tape 50 is a tape having pressure sensitive adhesive (PSA).

In another embodiment, the two elastic boards 32 are coupled to the two second side plates 222 integrally or in another ways.

In another embodiment, an inner surface of the contact portion 35 is arc-shaped, to press firmly against the component 10 having a round bottom.

The embodiments shown and described above are only examples. Many details are often found in the art such as the other features of a component holder. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A component holder for a component comprising:
a bracket comprising a bottom plate and a frame comprising a plurality of first side plates, and two second side plates perpendicularly to each other, and the plurality of the first side plates and two second side plates attached to the bottom plate to cooperatively form a receiving space shaped for receiving the component; and
two fixing members configured to be coupled to the two second side plates, and each of the fixing members comprising an elastic board extending into the receiving space and spaced from the corresponding second side plate, to urge against the component in a direction perpendicular to the corresponding second side plate.

2. The component holder of claim 1, wherein each elastic board comprises a bent portion extending upwards and outwards first and then downwards and outwards, and a contact portion extending downwards from a bottom end of the bent portion.

3. The component holder of claim 2, wherein the quantity of the first side plates is two, and the two first side plates are coupled to each other perpendicularly, the two second side plates are coupled to distal ends of the two first side plates respectively, the receiving space is square.

4. The component holder of claim 3, wherein a notch is defined between neighboring ends of the two second side plates.

5. The component holder of claim 2, wherein each fixing member further comprises a fixing board attached to the corresponding second side plate, and the bent portion extends from a side of the fixing board.

6. The component holder of claim 5, further comprising a plurality of fastening members, two through holes are defined in each fixing board, and a pair of fixing holes is defined in a top surface of each second side plate, the fastening members extend through the through holes of the two fixing boards and engage in the fixing holes of the two second side plates.

7. A component holder assembly comprising:
a component;
a bracket comprising a bottom plate and a frame comprising a plurality of first side plates and two second side plates perpendicularly to each other, and the plurality of the first side plates and two second side plates attached to the bottom plate to cooperatively form a receiving space for receiving the component; and
two fixing members configured to be coupled to the two second side plates, and each of the fixing members comprising an elastic board extending into the receiving space and be spaced from the corresponding second side plate, to be deformed by the component to allow the component to be sandwiched among the two elastic boards and the plurality of the first side plates.

8. The component holder assembly of claim 7, wherein each elastic board comprises a bent portion extending upwards and outwards first and then downwards and outwards, and a contact portion extending downwards from a distal end of the bent portion.

9. The component holder assembly of claim 8, wherein each fixing member further comprises a fixing board attached to the corresponding second side plate, and the bent portion extends from a side of the fixing board.

10. The component holder assembly of claim 9, further comprising a plurality of fastening members, two through holes are defined in each fixing board, and a pair of fixing holes is defined in a top surface of each second side plate, the fastening members extend through the through holes of the two fixing boards and engage in the fixing holes of the two second side plates.

11. The component holder assembly of claim 8, wherein the bottom of the component is round, and each contact portion is concavely arced.

12. The component holder assembly of claim 7, wherein the quantity of the first side plates is two, and the two first side plates are coupled to each other perpendicularly, the two second side plates are coupled to ends of the two first side plates away from a joint of the two first side plates respectively, and a bottom of the component and the receiving space are square.

13. The component holder assembly of claim 7, wherein the component is attached to the bottom plate by an adhesive tape.

14. The component holder assembly of claim 7, wherein the elastic boards urge against the component in two perpendicular directions perpendicular to the corresponding second side plates.

15. The component holder assembly of claim 7, wherein a notch is defined between neighboring ends of the two second side plates.

16. A component holder comprising:
a bracket having:
a bottom plate with a first surface and a second surface, the second surface opposite, and substantially parallel to the first surface;
a plurality of first side plates attached to the bottom plate and extending out substantially perpendicular from the first surface; and
a plurality of second side plates attached to the bottom plate and extending out substantially perpendicular from the first surface;
wherein, the plurality of first side plates and plurality of second side plates are positioned to co-operatively form a receiving space to receive a portion of a component to be held; and
one or more fixing members selectively attachable to at least one of the second side plates, each fixing member having an elastic portion extending into the receiving space when attached to a second side plate;
wherein, when the component portion is placed in the receiving space and the one or more fixing members attached to at least one of the second side plates, the elastic portion of the one or more attached fixing members urges the component portion against one or more first side plates to hold the component against the bracket.

17. The component holder of claim 16, wherein each elastic board comprises a bent portion extending upwards and outwards first and then downwards and outwards, and a contact portion extending downwards from a bottom end of the bent portion.

18. The component holder of claim 17, wherein the quantity of the first side plates is two, and the two first side plates are coupled to each other perpendicularly, the two second side plates are coupled to distal ends of the two first side plates respectively, the receiving space is square.

19. The component holder of claim 18, wherein a notch is defined between neighboring ends of the two second side plates.

20. The component holder of claim 17, wherein each fixing member further comprises a fixing board attached to the corresponding second side plate, and the bent portion extends from a side of the fixing board.
